(19) United States
(12) Patent Application Publication
(10) Pub. No.: US 2009/0193527 A1
(43) Pub. Date: Jul. 30, 2009

(54) METHOD FOR MONOTONICALLY COUNTING AND A DEVICE HAVING MONOTONIC COUNTING CAPABILITIES

(75) Inventors: Asaf Ashkenazi, Austin, TX (US); David Holmes Hartley, Seaview Downs (AU)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/376,069

(22) PCT Filed: Aug. 3, 2006
(86) PCT No.: PCT/IB2006/052672

§ 371 Date: Feb. 2, 2009

(51) Int. Cl. G06F 21/02; G06F 11/00

(52) U.S. Cl. 726/34

(57) ABSTRACT

A method for monotonically counting and a device having monotonically counting capabilities. The device includes: a monotonic counter, an input interface adapted to receive requests to update a value of the monotonic counter and an average request rate limiter circuit adapted to selectively reject a request if an amount of monotonic counter value updates within a predefined time window exceeded a threshold; wherein the threshold and the predefined time window are defined in response to at least one legitimate request pattern.

### FIELD OF THE INVENTION

The present invention relates to methods for monotonically counting and for devices having monotonically counting capabilities.

### BACKGROUND OF THE INVENTION

A monotonic counter is capable of counting in one direction only.

U.S. Pat. No. 6,882,699 of Waidart et al., being incorporated herein by reference, illustrates a prior art monotonic counter. Monotonic counters are used in various applications such as security application, copyright management application, testing applications and the like. They can be used in real time clock generators, time stamp mechanisms, built in self test devices for testing analog to digital converters, communications fabrics, and the like. The following U.S patents and patent applications, all being incorporated herein in reference, illustrate various applications of monotonic counters: U.S. Pat. No. 633,670 of England et al., U.S. Pat. No. 6,320,528 of Michal, U.S. Pat. No. 6,751,667 of Helliwell, U.S. patent application publication serial number 20050060549 of England et al., U.S. patent application publication serial number 20060020941 of Inamura et al., U.S. patent application publication serial number 200600156675 of Pangaul.

Monotonic counters signals can be tampered for various reasons including copyrighting piracy, concealing hacking or tampering attempts, reducing the functionality of a device and the like.

There is a need to provide a secure method for monotonically counting and a device having monotonic counting capabilities.

### SUMMARY OF THE PRESENT INVENTION

A method for monotonically counting and a device having monotonic counting capabilities, as described in the accompanying claims.

### BRIEF DESCRIPTION OF THE DRAWINGS

The present invention will be understood and appreciated more fully from the following detailed description taken in conjunction with the drawings in which:

FIG. 1 illustrates a device that includes a monotonic counter, according to an embodiment of the invention;

FIG. 2 illustrates a device that includes a monotonic counter, according to another embodiment of the invention;

FIG. 3 illustrates a method for monotonically counting according to an embodiment of the invention; and

FIG. 4 illustrates a method for monotonically counting according to another embodiment of the invention.

### DETAILED DESCRIPTION OF PREFERRED EMBODIMENTS

Embodiments of the present invention illustrated in the accompanying drawings provide a method for monotonically counting and a device having monotonic counting capabilities.

The device includes an input interface adapted to receive requests to update a value of a monotonic counter, a monotonic counter and an average request rate limiter circuit adapted to selectively reject a request if an amount of monotonic counter value updates within a predefined time window exceeded a threshold. The threshold and the predefined time window are defined in response to at least one legitimate request pattern.

The method includes: receiving requests to update a value of a monotonic counter and determining whether to reject the request in response to a relationship between an amount of requests received during a predefined time window and between the threshold. The threshold and the predefined time window are defined in response to legitimate request pattern such as but not limited to short term legitimate request burst.

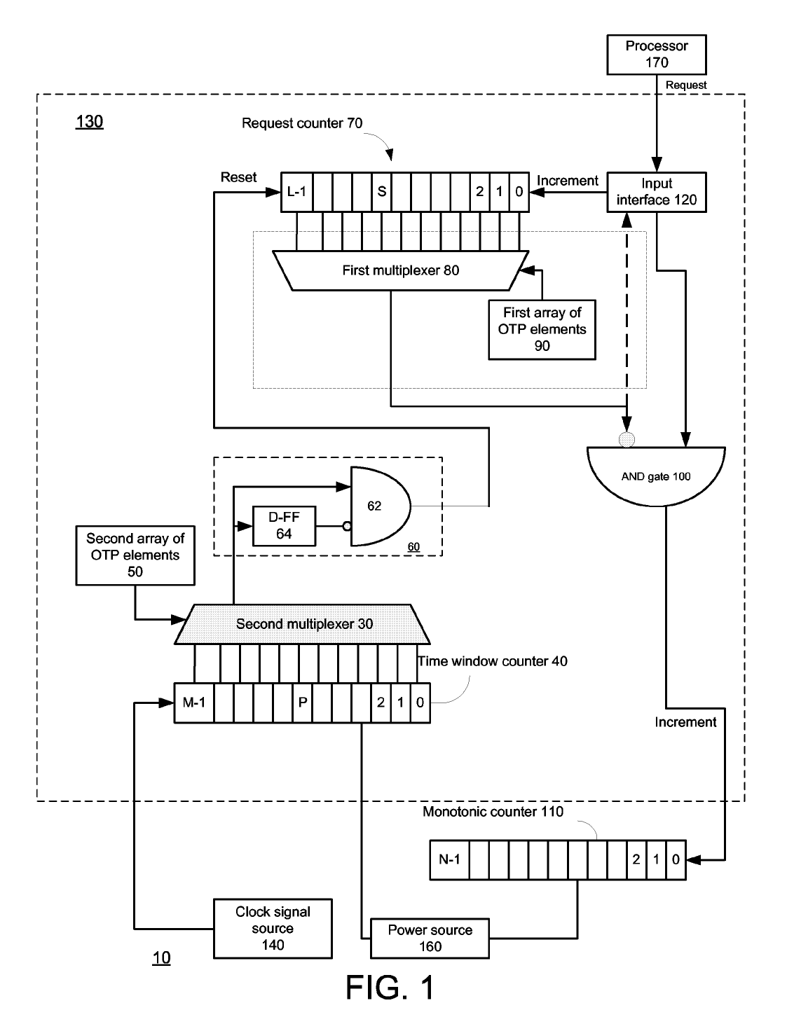

FIG. 1 illustrates device 10 according to an embodiment of the invention. Device 10 has information (data and/or media) processing capabilities. Device 10 can be a mobile device such as but not limited to laptop computer, a mobile phone, a media player, a mobile game console and the like. Device 10 can also be a stationary apparatus such as a desktop computer, a plasma screen, a television, a media entertainment system, a security/monitoring system, a stationary game console, a network node, a router, a switch, and the like. Device 10 can include one or more displays, processors, memory units, loudspeakers, microphones, DMA controllers, and the like. Device 10 can include one or more integrated circuits.

Referring to FIG. 1 device 10 includes: N-bit monotonic counter 110, input interface 120 and average request rate limiter circuit 130.

Device 10 can also include processor 170 that is adapted to generate requests to update the value of the monotonic counter. It is noted that such requests can be generated by more than a single component or circuit. It is assumed that device 10 either includes these components or circuits or merely receives these requests.

If the monotonic counter 110 is configured to count up then the requests are requests to increment the value of the counter. If the monotonic counter 100 is configured to count down then the requests are requests to decrement the value of the counter.

Conveniently, device 10 also includes power source 160 or an interface for receiving power. The power source 160 can be a battery, a backup battery, a power cell, and the like.

Input interface 120 is connected to average request rate limiter circuit 130. The average request rate limiter circuit 130 is also connected to monotonic counter 110.

Average request rate limiter circuit 130 is adapted to selectively reject a request that if an amount of monotonic counter value updates within a predefined time window exceeded a threshold. It is noted that the threshold and the predefined time window are defined in response to at least one legitimate request pattern. Such legitimate request patterns can include legitimate short-term request bursts, normal rate requests received during long time periods and the like.

Conveniently the monotonic counter 110 is not scheduled to roll over during the lifespan of device 10 but this is not necessarily so. Thus, the size of the monotonic counter should be designed in view of legitimate request patterns as well as the lifespan of the device. The inventors used a 32-bit long monotonic counter 110 and allowed a request rate of 512, 1024, 2048, 4096 or 8192 requests per a time window of 512 seconds long. The selection between these amounts was done using a first one-time programmable hardware module 150 that includes a first one-time programmable array 90 that is connected to a first multiplexer 80 such as to send the first multiplexer 80 a selection signal. The first one-time programmable array 90 included four one-time programmable elements. Accordingly the threshold was set to wither one of 512, 1024, 2048, 4096 or 8192 requests, by setting the appropriate one-time programmable elements.

First multiplexer 80 has multiple inputs, each connected to a unique cell (bit) of request counter 70.

The selection signal selects which cell (bit) out of multiple cells of request counter 70 should be selected by first multiplexer 80 and sent to AND gate 100. The AND gate performs an AND operation between an inverted value of the selected bit and a request signal that is asserted when a request to alter a value of the monotonic counter arrives to input interface 120.

If the value of the selected bit is zero then the inverted value is one AND gate 100 propagates requests to alter the value of the monotonic counter to the monotonic counter 110.

If the value of the selected bit is one then the inverted value is zero thus requests to alter the value of the monotonic counter are masked.

Average request rate limiter circuit 130 includes M-bit time window counter 40 that counts clock cycles and a selected bit change circuit 60 adapted to send a reset signal to L-bit request counter 70 once a value of a selected bit changes.

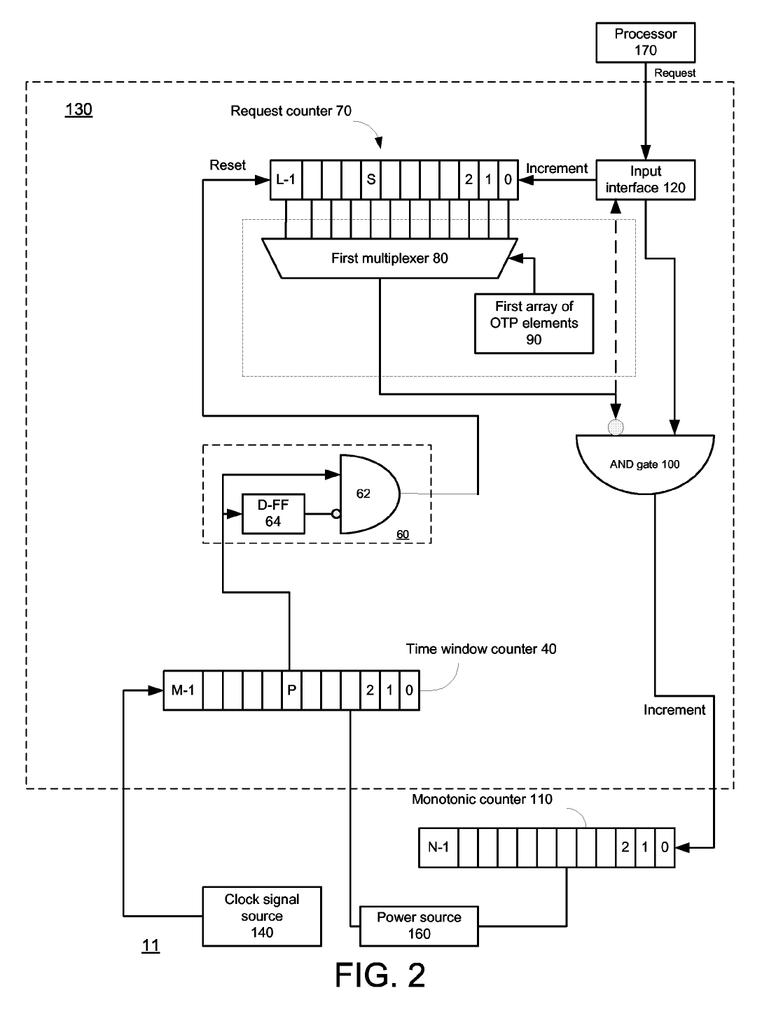

Selected bit change circuit 60 can be connected directly to the selected cell (bit) of time window counter 40 (as illustrated in FIG. 2) or be connected to the time window counter 40 via second multiplexer 30 and second one-time programmable array 50 (as illustrated in FIG. 1).

Second one-time programmable array 50 is adapted to generate a selection signal that is provided to second multiplexer 30 that has multiple inputs that are connected to multiple cells (bits) of time window counter 40. In response to the selection signal second multiplexer 30 outputs the selected bit to selected bit change circuit 60.

Selected bit change circuit 60 compares between a current value of the selected bit to a previous value of that selected bit. Conveniently the selected bit change circuit includes a D-type flip-flop 64. The input of the D-type flip-flop 64 as well as a first input of AND gate 162 receive the selected bit. The output of the D-type flip-flop 64 is connected to an inverted input of the AND gate 62. This configuration sends a reset signal to request counter 70 once the value of the selected but changes.

It is noted that request counter 70 freezes (stops counting) when the output of first multiplexer 80 is asserted. In other words first multiplexer 80 can mask or gate input interface 120, as illustrated by the dashed arrow that is connected from the output of first multiplexer 80 to input interface 120. Input interface 120 will not output increment signals after the output of first multiplexer 80 was asserted. Conveniently, when selected bit change circuit 60 resets request counter 70 the output of first multiplexer changes from ‘1’ to ‘0’ and the freezing of input interface 120 is canceled.

FIG. 2 illustrates device 11 that includes a monotonic counter, according to another embodiment of the invention. Device 11 of FIG. 2 differs from device 10 of FIG. 1 by not including second group of one-time programmable elements 50 and not including second multiplexer 30. Thus, selected bit change circuit 60 is hard wired to a certain cell of time window counter.

It is noted that device 10 and device 11 monitor a value of a selected bit of request counter 70 and of time window counter 40. For example, assuming that the P′th bit of time window counter 40 is monitored and that the S′th bit of request counter 70 is monitored.

This configuration allows determining when the value of a counter reaches a power of two. Thus, this configuration detects when the time window counter reaches 2^{P+1} and when the request counter reaches 2^{S+l}.

It is noted that device 10 and 11 can also monitor the values of multiple bits within a single counter in order to determine when a value of a counter reaches (of passes) a value that differs from a power of two.

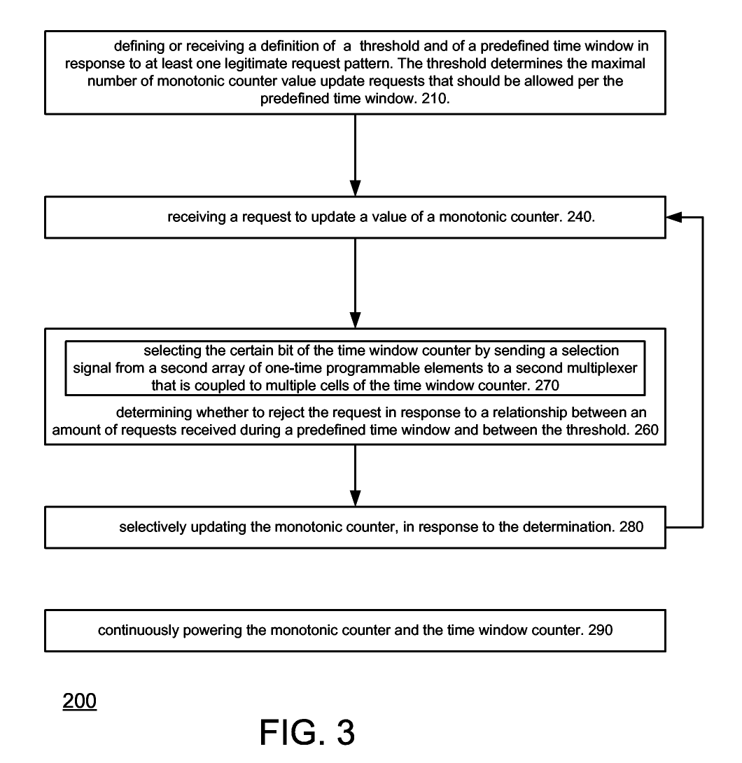

FIG. 3 illustrates method 200 for monotonically counting according to an embodiment of the invention.

Method 200 starts by stage 210 of defining or receiving a definition of a threshold and of a predefined time window in response to at least one legitimate request pattern. The threshold determines the maximal number of monotonic counter value update requests that should be allowed per the predefined time window.

Conveniently the definition is responsive to legitimate short time bursts, to long term lower rate requests and the like.

Conveniently stage 210 includes setting the threshold by a first one-time programmable hardware module.

Stage 210 is followed by stage 240 of receiving requests to update a value of a monotonic counter.

Stage 240 is followed by stage 260 of determining whether to reject the request in response to a relationship between an amount of requests received during a predefined time window and between the threshold. Conveniently, stage 260 includes rejecting a request if an amount of monotonic counter value updates received within a predefined time window exceeded a threshold.

The time window can be a sliding window that has a predefined length. As time passes by old requests are not taken into account. According to another embodiment of the invention multiple consecutive predefined time windows are defined. Once a time window expires the number of previously counted requests is reset.

Conveniently, stage 260 of determining includes monitoring whether a value of a certain bit of a request counter changes. This monitoring can include selecting the certain bit by sending a selection signal from a first array of one-time programmable elements to a first multiplexer that is coupled to multiple cells of the request counter.

Conveniently, stage 260 of determining includes monitoring whether a value of a certain bit of a time window counter changes and in response to a change resetting a request counter.

According to an embodiment of the invention stage 260 includes stage 270 of selecting the certain bit of the time window counter by sending a selection signal from a second array of one-time programmable elements to a second multiplexer that is coupled to multiple cells of the time window counter.

Stage 260 is followed by stage 280 of selectively updating the monotonic counter, in response to the determination. Stage 280 can be followed by stage 240.

Conveniently, method 200 includes stage 290 of continuously powering the monotonic counter and the time window counter.

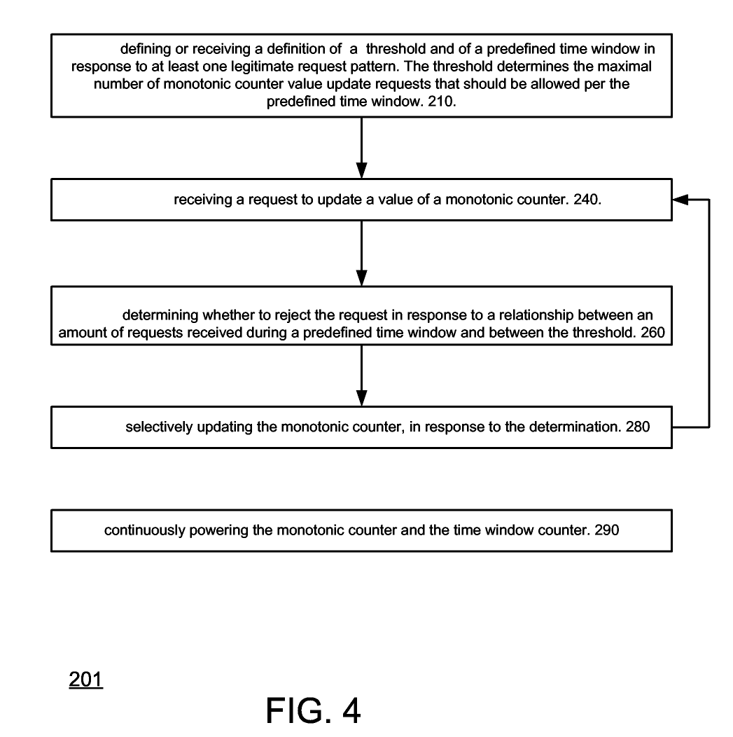

Method 201 of FIG. 4 differs from method 200 of FIG. 3 by not including stage 270. Thus, the selecting can be done in a different manner. For example, the selection can be made by connecting a certain bit of the time window counter to a monitoring circuit such as bit change circuit 60.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A device having monotonically counting capabilities, the device comprises:
a monotonic counter;
a rate limiter circuit;
an input interface adapted to receive requests to update a value of the monotonic counter;
wherein the monotonic counter and the average request rate limiter circuit are adapted to selectively reject a request if an amount of monotonic counter value updates within a predefined time window exceeded a threshold;
wherein the threshold and the predefined time window are defined in response to at least one legitimate request pattern.

2. The device according to claim 1 wherein the threshold is set by a first one-time programmable hardware module.

3. The device according to claim 2 wherein the first one-time programmable hardware module comprises;
a first group of one-time programmable elements adapted to generate a selection signal that is provided to a first multiplexer that has multiple inputs that are coupled to multiple cells of a request counter that counts a number of receiver requests per time window.

4. The device according to claim 1 wherein the average request rate limiter circuit comprises:
a time window counter that counts clock cycles and a selected bit change circuit adapted to send a reset signal to a request counter once a value of a selected bit changes.

5. The device according to claim 4 wherein the average request rate limiter circuit comprises:
a second group of one-time programmable elements adapted to generate a selection signal that is provided to a second multiplexer that has multiple inputs that are coupled to multiple cells of the time window counter and wherein the second multiplexer outputs the selected bit.

6. The device according to claim 1 further comprising a power source adapted to continuously power the monotonic counter and a time window counter.

7. The device according to claim 1 further comprising a processor adapted to generate requests to update the value of the monotonic counter.

8. A method for monotonically counting, the method comprises:
receiving requests to update a value of a monotonic counter;
determining whether to reject the request in response to a relationship between an amount of requests received during a predefined time window and between the threshold; wherein the threshold and the predefined time window are defined in response to legitimate request pattern.

9. The method according to claim 8 further comprising defining the threshold and the predefined time window in response to at least one legitimate request pattern.

10. The method according to claim 8 wherein the defining comprises:
setting the threshold by a first one-time programmable hardware module.

11. The method according to claim 8 wherein determining comprises:
monitoring whether a value of a certain bit of a request counter changes;
wherein the monitoring comprises selecting the certain bit by sending a selection signal from a first array of one-time programmable elements to a first multiplexer that is coupled to multiple cells of the request counter.

12. The method according to claim 8 wherein the determining comprises:
monitoring whether a value of a certain bit of a time window counter changes; and
in response to a change, resetting a request counter.

13. The method according to claim 8 wherein the determining comprises
selecting the certain bit of the time window counter by sending a selection signal from a second array of one-time programmable elements to a second multiplexer that is coupled to multiple cells of the time window counter.

14. The method according to any claim 8 of further comprising continuously powering a monotonic counter and a time window counter.

15. The method according to claim 9, wherein the defining comprises:
setting the threshold by a first one-time programmable hardware module.

16. The method according to claim 9 wherein determining comprises:
monitoring whether a value of a certain bit of a request counter changes;
wherein the monitoring comprises selecting the certain bit by sending a selection signal from a first array of one-time programmable elements to a first multiplexer that is coupled to multiple cells of the request counter.

17. The method according to claim 9 wherein the determining comprises:
monitoring whether a value of a certain bit of a time window counter changes; and
in response to a change, resetting a request counter.

18. The method according to claim 9 wherein the determining comprises:
selecting the certain bit of the time window counter by sending a selection signal from a second array of one-time programmable elements to a second multiplexer that is coupled to multiple cells of the time window counter.

19. The method according to claim 9 of further comprising continuously powering a monotonic counter and a time window counter.

20. The method according to claim 11 of further comprising continuously powering a monotonic counter and a time window counter.
